(19) United States
(12) Patent Application Publication
(10) Pub. No.: US 2025/0141639 A1
(43) Pub. Date: May 1, 2025

(54) RECOVERY FROM BSS COLOR COLLISION

(71) Applicant: HEWLETT PACKARD ENTERPRISE DEVELOPMENT LP, Spring, TX (US)

(72) Inventors: Xiaoyang Fu, Beijing (CN); Xuguang Jia, Beijing (CN); Qiang Zhou, Sunnyvale, CA (US)

(21) Appl. No.: 18/498,214

(22) Filed: Oct. 31, 2023

(51) Int. Cl. H04L 5/00

(52) U.S. Cl. CPC H04L 5/0091

(57) ABSTRACT

Implementations of the present disclosure relate to recovery from BSS color collision. The method comprises determining a first basic service set (BSS) color of a BSS for communications between the first AP and a client device. The method further comprises determining a second BSS color of the BSS for communications between the first AP and a second AP. In this case, the second BSS color is different from the first BSS color. The method further comprises detecting that the first BSS color is used by a neighboring BSS. Lastly, the method further comprises changing the first color of the BSS to a third color for communications between the first AP and the client device. In this way, by sparing the BSS color switch time between the APs, the recovery from the BSS color collision event for the entire BSS is facilitated.

### BACKGROUND

A basic service set (BSS) coloring mechanism is developed to minimize the interference from an overlapping BSS (OBSS). Devices supporting the BSS coloring mechanism may configure a BSS color value in the data frame. When a BSS color mechanism supporting device receives a data frame from a further device operating in the same frequency space, the device may check the BSS color value contained in the header. If the BSS color value contained in the header is not the same as the BSS color used by the device, the device may identify that the data frame is from a further device in an overlapping BSS. The device will drop the data frame. With devices of each BSS transmitting a locally unique color, a device can quickly and easily distinguish transmissions coming from its BSS from those of a neighboring BSS.

### BRIEF DESCRIPTION OF THE DRAWINGS

Implementations of the present disclosure may be understood from the following Detailed Description when read with the accompanying figures. In accordance with the standard practice in the industry, various features are not drawn to scale. In fact, the dimensions of the various features may be arbitrarily increased or reduced for clarity of discussion. Some examples of the present disclosure are described with respect to the following figures:

FIGS. 1A-1C illustrate example network environments in which example implementations of the present disclosure may be implemented;

FIG. 2 illustrates a signaling diagram for an example communication procedure in accordance with some example implementations of the present disclosure;

FIG. 3 illustrates a flowchart of an example BSS color switch method in accordance with some example implementations of the present disclosure;

FIG. 4 illustrates a schematic diagram for an example BSS color switch procedure in accordance with some example implementations of the present disclosure;

FIG. 5 illustrates a schematic diagram for an example BSS color issue detection procedure in accordance with some example implementations of the present disclosure; and

FIG. 6 illustrates a block diagram of an example AP in accordance with some example implementations of the present disclosure.

### DETAILED DESCRIPTION

The BSS color mechanism provides a basis for spatial reuse. However, due to some calculation issues, one color may be used by two overlapping BSS (OBSS), which would cause transmission problems. For example, when one AP receives a data frame from an OBSS using the same BSS color, the AP will not be able to determine whether the data frame is an intra frame or an inter frame just by checking the BSS color value in the physic (PHY) header. The AP still has to check the device information, such as address or BSSID, to classify the data frame.

In this regard, in order to maintain the convenience brought by the BSS color mechanism, the BSS color has to be switched to a new and non-overlapping BSS color. Thus, a BSS color switch procedure is introduced. Conventionally, all the communications in one BSS are implemented with the same color. When a BSS color collision event is detected, the AP will imitate the BSS color switch procedure for all the devices in the BSS.

However, in a multi-hop or mesh network, if one client device detects a BSS color collision, all devices in the network need to change the BSS color. For example, in the mesh network, if any of the mesh portal points (MPP) and mesh points (MP) detect a BSS color collision, the BSS color in the mesh network must be changed. During the change of the BSS color, the MPs in a linear topology change the BSS color sequentially, which would cause link flapping and transmission delay.

In view of the above, various example implementations of the present disclosure propose a fast recovery mechanism from a BSS color collision for multi-hop networks. In this invention, the communications among access points (APs) in one basic service set (BSS) use the same BSS color. In the meantime, the respective communication between one of the APs and its associated client device in the same BSS uses another BSS color. When a BSS color collision event is detected, the BSS color used for the communication between APs and associated client devices will be changed, and the BSS color used for the communication between APs will be maintained.

When a BSS color collision event is detected, the APs in a data path for multi-hop communication will perform the BSS color switch procedures one by one, which would consume a large amount of time. With the implementations in accordance with the present disclosure, since the BSS color used for the communications between the APs will not change, the BSS color switch time is spared. The recovery time of the BSS from the BSS color collision event will be significantly reduced.

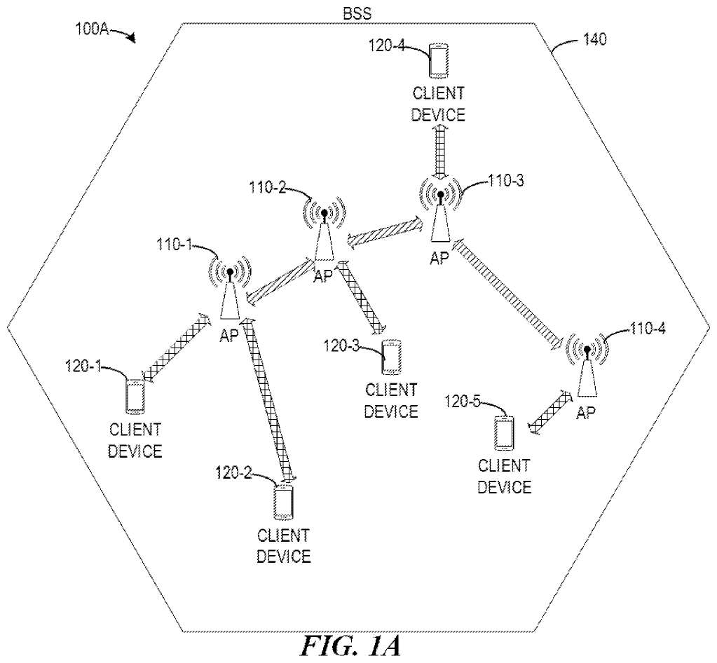

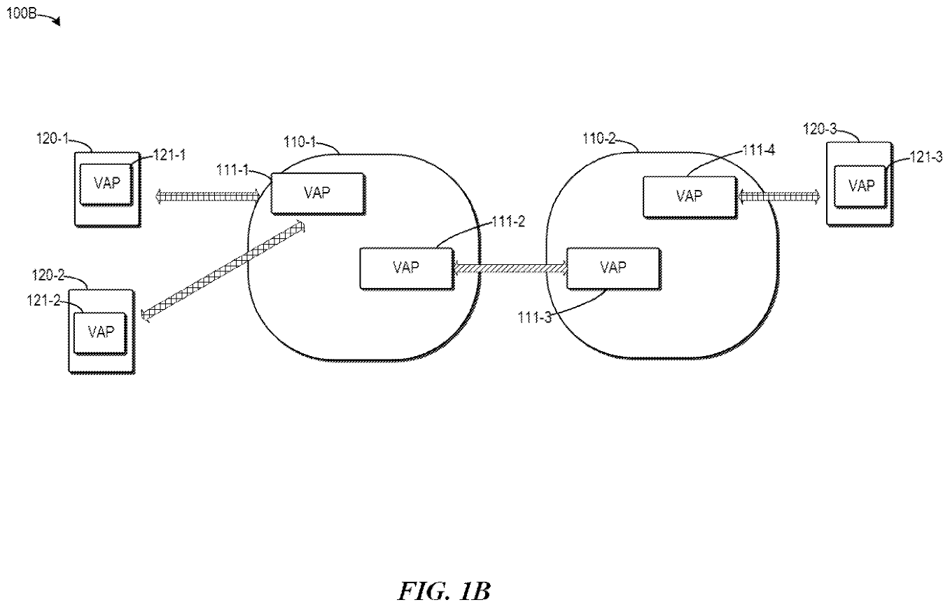

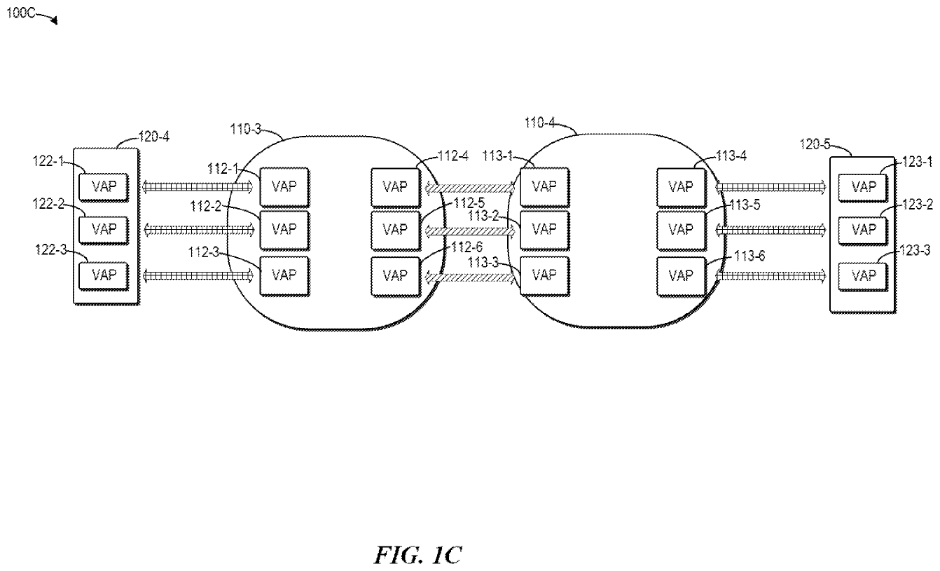

FIG. 1A illustrates an example network environment 100A in which example implementations of the present disclosure may be implemented. As illustrated in FIG. 1A, the environment 100A includes a multi-hop network formed by a plurality of access points and a plurality of client devices. The plurality of APs includes an AP 110-1, an AP 110-2, an AP 110-3, and an AP 110-4 (may referred to as the plurality of APs 110). The plurality of client devices includes a client device 120-1, a client device 120-2, a client device 120-3, a client device 120-4, and a client device 120-5 (may referred to as the plurality of client devices 120). The plurality of APs 110 provides a BSS 140. Each of the plurality of client devices 120 is in the serving range covered by the BSS 140. The client device 120-1 and the client device 120-2 are associated with the AP 110-1. The client device 120-3 is associated with the AP 110-2. The client device 120-4 is associated with the AP 110-3. The client device 120-5 is associated with the AP 110-4.

In the multi-hot network, a data frame from one client device 120 may be relayed several times by several APs before it reaches a wired network. For example, a data frame from the client device 120-2 may be transmitted to the AP 110-1 with which the client device 120-2 is associated. After the AP 110-1 receives the data frame, the AP 110-1 may relay the data frame to the AP 110-2 according to a predefined data flow path. Similarly, after the AP 110-2 receives the relayed data frame, the AP 110-2 also relays the data frame to the AP 110-3. The AP 110-3 may serve as the endpoint and transmit the data frame to the wired network.

In some example implementations, the multi-hot network may be a mesh network. In these implementations, the AP 110-1, the AP 110-2, and the AP 110-4 may be mesh point APs, and the AP 110-3 may be the mesh portal point AP. The data frames may all be transmitted to the wired network at the AP 110-3.

As discussed above, all APs that are members of a BSS or a multiple BSSID set or co-hosted BSSID set shall use the same BSS color, while the client devices associated with the APs may follow the APs and also use the same BSS color. However, in the illustrated implementation, the plurality of APs 110 uses one BSS color to communicate with each other and uses another BSS color to communicate with the client devices. For example, when the AP 110-1 starts the BSS 140, the AP 110-1 may set the BSS color subfield of a frame it transmits to a value in the range of 1 to 63. In this case, the AP 110-1 may select one BSS color of value 5 for communication between the APs and select one BSS color of value 15 for communication with the client devices. For example, the BSS color of value 5 may be used for the communications between the AP 110-1 and the AP 110-2, between the AP 110-2 and the AP 110-3, and between the AP 110-3 and the AP 110-4. The BSS color of value 15 may be sued for the communications between the AP 110-1 and the client devices 120-1 and 120-2, between the AP 110-2 and the client devices 120-3, between the AP 110-3 and the client devices 120-4 and between the AP 110-5 and the client devices 120-4.

In some example implementations, when the client device 120-2 transmits a data frame to the AP 110-1, the client device 120-2 sets the BSS color subfield in the data frame to be value 15. Upon receipt of the data frame, the AP 110-1 checks the BSS color of the data frame and determines that the data frame is from a client device with which it is associated. The AP 110-1 sets the BSS color subfield in the data frame to be value 5 and transmits the updated data frame to the AP 110-2 according to the predefined data path.

In some example implementations, one of the plurality of APs 110 or one of the pluralities of client devices 120 may detect a data frame from an OBSS that uses the same BSS color of value 5 or value 15, which means a BSS color collision occurs. For example, if the BSS color of value 5 is also used by the OBSS, a BSS color switch procedure will be implemented for the links established between the plurality of APs and the BSS color used for the links established between the APs and the client devices may be maintained. Accordingly, if the BSS color of value 15 is also used by the OBSS, a BSS color switch procedure will be implemented for the links established between the APs and the client devices while the BSS color used for the links established between the APs may be maintained.

FIG. 1B illustrates an example connection framework 100B between the devices as illustrated in FIG. 1A. It should be noted for clarity purpose without loss of generality, only the AP 110-1 and the AP 110-2 as well as the client device 120-1, the client device 120-2, and the client device 120-3 are illustrated in FIG. 1B. In order to use different BSS color for different devices, the AP 110-1 comprises a virtual access point (VAP) 111-1 and a VAP 111-2. Similarly, the AP 110-1 comprises a virtual access point (VAP) 111-1 and a VAP 111-2. The client device 120-1 comprises a VAP 121-1. The client device 120-2 comprises a VAP 121-2. The client device 120-3 comprises a VAP 121-3. Both the VAP 121-1 of the client device 120-1 and the VAP 121-2 of the client device 120-2 are associated with the VAP 111-1 of the AP 110-1. The VAP 121-1 of the client device 120-1 and the VAP 121-2 of the client device 120-2 may communicate with the VAP 111-1 of the AP 110-1 with the BSS color of value 15. On the other side, the VAP 111-4 of the AP 110-2 is associated with the VAP 121-3 of the AP 120-3, and the VAP 111-4 of the AP 110-2 also communicates with the VAP 121-3 of the AP 120-3 with the BSS color of value 15. The VAP 111-2 of the AP 120-1 is associated with the VAP 111-3 of the AP 110-2, and the VAP 111-2 of the AP 120-1 communicates with the VAP 111-3 of the AP 110-2 with the BSS color of value 5. In this way, by provisioning different VAPs for different BSS color, the multi-color BSS can be established.

In some example implementations, some of the devices in the BSS 140, as illustrated in FIG. 1A are multi-link devices (MLDs). FIG. 1C illustrates an example MLD connection framework 100C between the devices as illustrated in FIG. 1A. It should be noted for clarity purposes without loss of generality, only the AP 110-3 and the AP 110-4, as well as the client device 120-4 and the client device 120-5, are illustrated in FIG. 1C. In the illustrated implementation, the AP 110-3 and the AP 110-4 are both AP MLDs, and the client device 120-4 and the client device 120-5 are non-AP MLDs.

The client device 120-4 includes three VAPs for connecting with AP 110-3, including a VAP 122-1, a VAP 122-2, and a VAP 122-3. Correspondingly, the AP 110-3 includes a VAP 112-1, a VAP 112-2, and a VAP 112-3. Three links have been established between the client device 120-4 and the AP 110-3, including a link between the VAP 122-1 of the client device 120-4 and the VAP 112-2 of the AP 112-1 and a link between the VAP 122-3 of the client device 120-4 and the VAP 112-3 of the AP 112-1. These three links use the BSS color of value 15.

The client device 120-5 includes three VAPs for connecting with AP 110-4, including a VAP 123-1, a VAP 123-2 and a VAP 123-3. Correspondingly, the AP 110-4 includes a VAP 112-1, a VAP 112-2, and a VAP 112-3. Three links have been established between the client device 120-4 and the AP 110-3, including a link between the VAP 122-1 of the client device 120-4 and the VAP 112-1 of the AP 112-1, a link between the VAP 122-2 of the client device 120-4 and the VAP 112-2 of the AP 112, and a link between the VAP 122-3 of the client device 120-4 and the VAP 112-3 of the AP 112-1. These three links use the BSS color of value 15.

The AP 110-3 further comprises a VAP 112-4, a VAP 112-5, and a VAP 112-5 for connecting with the other AP 110-4. The AP 110-4 further comprises a VAP 113-1, a VAP 113-2, and a VAP 113-3. Similarly, three links have been established, including a link between the VAP 112-4 of the AP 110-3 and the VAP 113-1 of the AP 112-1, a link between the VAP 122-2 of the client device 120-4 and the VAP 112-2 of the AP 112, and a link between the VAP 122-3 of the client device 120-4 and the VAP 112-3 of the AP 112-1. These three links use the BSS color of value 5.

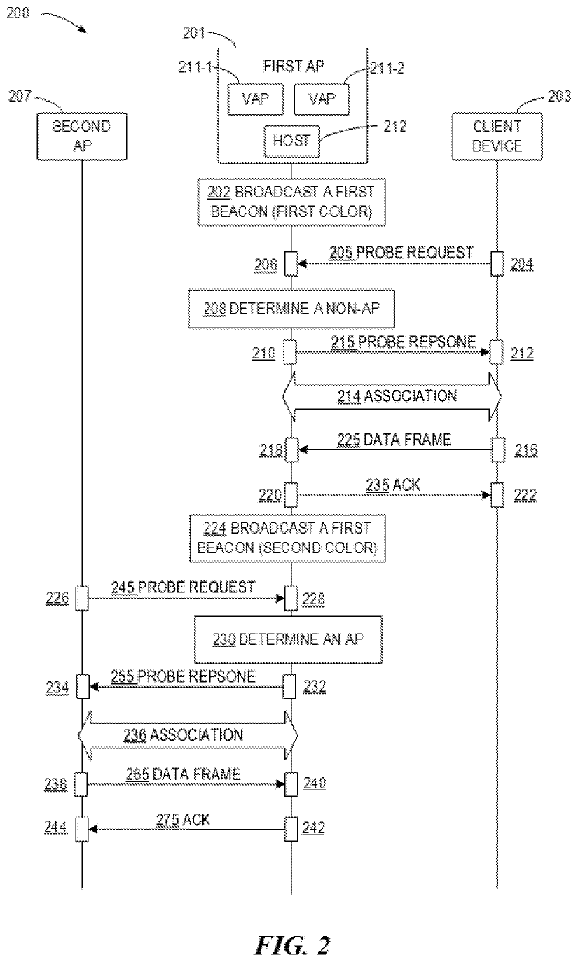

FIG. 2 illustrates a signaling diagram for an example communication procedure 200 in accordance with some example implementations of the present disclosure. The communication procedure 200 is implemented between a first AP 201 and a second AP 207, as well as a client device 203. The first AP 201 comprises a host part 212 to determine some of the functions and two VAP 211-1 and VAP 211-2. As discussed above, in order to implement the communication with two different BSS colors, the first AP 201 has two VAPs, including a VAP 211-1 for connecting with AP devices and a VAP 211-2 for connecting with client devices.

In the discovery stage, both VAP 211-1 and the VAP 211-2 of the first AP 201 broadcast beacon frames for presence announcement, respectively. In the illustrated implementation, at 202, VAP 211-2 of the first AP 201 broadcasts a first beacon with a first BSS color for passive scan periodically. In this case, the first beacon may contain its own SSID (Service Set Identifier), channel assignment, and security settings. For example, the first beacon may contain a BSS color field of a BSS color of value 15. In some example implementations, the first AP 201 may be a high efficiency (HE) device that operates in frequency bands between 1 GHZ and 7.125 GHz. In this implementation, the beacon frame transmitted by the first AP 201 may contain a HE operation element, which includes a BSS color value.

When a client device 203 detects the beacon frame from the first AP 201, the client device 203 may be aware of the first BSS color indicated by the beacon frame. The client device 203 may proceed to perform the discovery procedure. At 204, the client device 203 transmits a probe request 205 to the first AP 201. At 206, the first AP 201 receives the probe request 205 from the client device 203. At 208, when the first AP 201 obtains the probe request 205, the first AP 201 determines that the client device 203 is non-AP according to the device information contained in the probe request 205. For example, an address of the client device 203 may indicate that the client device 203 is not in the list of neighbor APs maintained by the first AP 201. At 210, the first AP 201 transmits a probe response 215 to the client device 203. At 212, the client device 203 receives the probe response 215 from the first AP 201, and the discovery procedure is complete.

After the discovery procedure, at 214, the first AP 201 and the client device 203 perform an association procedure. For example, the client device 203 may transmit an authentication request to imitate the authentication. After the client device 203 receives an authentication response from the first AP 201, the client device may transmit an association request to the first AP 201 and receive an association response from the first AP 201. As a result, the client device 203 is associated with the first AP 201, i.e., the VAP 211-2 of the first AP 201.

After the association procedure is complete, the client device 203 may communicate with the VAP 211-2 of the first AP 201. At 216, the client device 203 transmits a data frame 225 to the VAP 211-2 of the first AP 201. In this case, the data frame 225 contains a BSS color value of the first BSS color. At 218, the first AP 201 receives the data frame 225 and processes the data frame 225 with the host 212. The host 212 of the first AP 201 parses the data frame 225 and checks the BBS color value contained in the data frame 225 is consistent with the first BSS color. In some example implementations, the first AP 201 may receive all the data frames and determine whether a BSS color indicator contained in a received data frame matches one of the two BSS color indicators. If the first AP 201 determines that the BSS color indicator matches one of the two predefined BSS color indicators, the first AP 201 determines the data frame as an intra frame. Otherwise, if the first AP 201 determines that the BSS color indicator does not match any of the two predefined BSS color indicators, the first AP 201 determines the data frame as an inter frame.

At 220, after the first AP 201 determines the data frame 225 is an intra frame, the first AP 201 transmits an acknowledgment frame 235 to the client device 203. At 222, the client device 203 receives the acknowledgment frame 235 from the first AP 201. In some further implementations, when the first AP 201 transmits a data frame to the client device 203, the data frame also contains a field indicating the first BSS color.

Since the first AP 201 also broadcasts beacons with a different BSS color for connecting with APs, another communication procedure may be performed concurrently or sequentially. In the illustrated implementation, at 224, the VAP 211-1 of the first AP 201 broadcasts a second beacon with a second BSS color for passive scan periodically. In this case, the second beacon may contain its own SSID, channel assignment, and security settings, which are different from that of the first beacon. For example, the second beacon may contain a BSS color field of a BSS color of value 5. In the case of the first AP 201 being a HE device, the second beacon frame transmitted by the first AP 201 may contain a HE operation element, which includes a BSS color value of 5.

When a second AP 207 detects the beacon frame from the first AP 201, the second AP 207 may be aware of the second BSS color indicated by the second beacon. The second AP 207 may proceed to perform the discovery procedure. At 226, the second AP 207 transmits a probe request 245 to the first AP 201. At 228, the first AP 201 receives the probe request 245 from the second AP 207. At 230, when the first AP 201 obtains the probe request 245, the first AP 201 determines that the second AP 207 is an AP according to the device information contained in the probe request 245. At 232, the first AP 201 transmits a probe response 255 to the second AP 207. At 234, the second AP 207 receives the probe response 255 from the first AP 201, and the discovery procedure is complete.

After the discovery procedure, at 236, the first AP 201 and the second AP 207 perform an association procedure. For example, the second AP 207 may transmit an authentication request to imitate the authentication. After the second AP 207 receives an authentication response from the first AP 201, the second AP 207 may transmit an association request to the first AP 201 and receive an association response from the first AP 201. As a result, the second AP 207 is associated with the first AP 201, i.e., the VAP 211-1 of the first AP 201.

After the association procedure is complete, the second AP 207 is able to communicate with the VAP 211-1 of the first AP 201. At 238, the second AP 207 transmits a data frame 265 to the VAP 211-2 of the first AP 201. In this case, the data frame 265 contains a BSS color value of the second BSS color. At 240, the first AP 201 receives the data frame 265 and processes the data frame 265 with the host 212. The host 212 of the first AP 201 parses the data frame 265 and checks whether the BBS color value contained in the data frame 265 is consistent with the second BSS color. At 242, after the first AP 201 determines the data frame 265 is an intra frame, the first AP 201 transmits an acknowledgment frame 275 to the client device 203. At 244, the second AP 207 receives the acknowledgement frame 275 from the first AP 201. In some further implementations, when the first AP 201 transmits a data frame to the second AP 207, the data frame also contains a field indicating the second BSS color.

In some example implementations, a device may detect both the first beacon and the second beacon. If a client device detects a second beacon containing the second BSS color for connecting with APs and attempts to associate with the AP according to the information contained in the second beacon by transmitting a probe request, the client device will be rejected. When the client device attempts to associate with the AP according to the information contained in the first beacon, the client device will be accepted. With the illustrated implementation, communications with different types of devices with different BSS colors can be successfully performed without interferences.

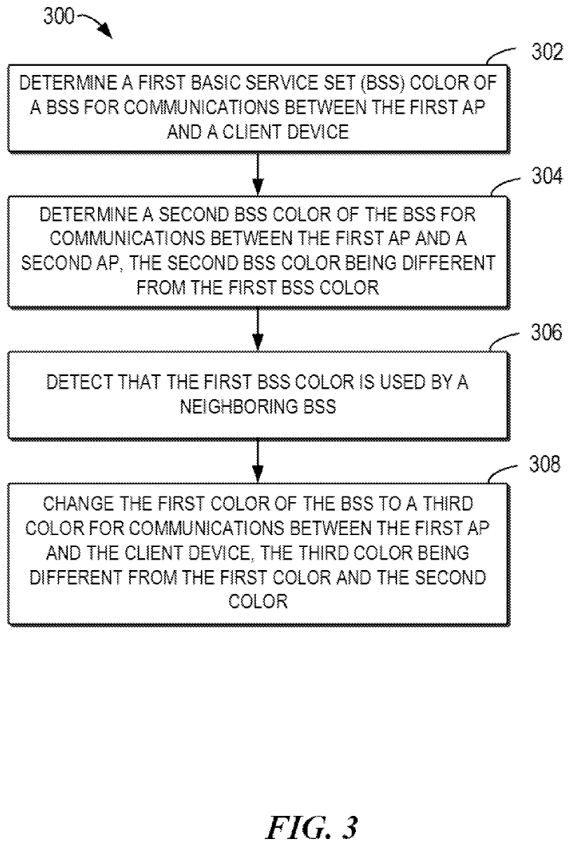

Although the BSS coloring mechanism may provide various advantages for high-density network communications, it is possible that BSS color collision may occur between two overlapping neighbor BSSs. When a BSS color collision occurs, the BSS color needs to be changed. FIG. 3 illustrates a flowchart of an example BSS color switch method 300 in accordance with some example implementations of the present disclosure. For description purposes, the method 300 will be described in association with FIGS. 1A-1C and 2. For example, the method 300 may be implemented by one of the plurality of APs 110, as illustrated in FIGS. 1A-1C under a communication framework, as illustrated in FIG. 2.

As illustrated in FIG. 3, at 302, the first AP determines a first BSS color of a BSS for communications between the first AP and a client device. For example, in the implementation illustrated in FIG. 1A, the AP 110 may determine a first BSS color of a BSS color value of 15 for combinations between the first AP and the client devices. At 304, the first AP determines a second BSS color of the BSS for communications between the first AP and a second AP. In this case, the second BSS color is different from the first BSS color. For example, in the implementation illustrated in FIG. 1A, the AP 110 may determine a second BSS color of a BSS color value of 5 for communications between the first AP and a second AP in the same BSS.

In some example implementations, the AP 110 may select a first BSS color for combinations between the first AP and the client devices and a second BSS color for communications between APs when the AP 110 starts the BSS. In the case of HE AP, one of two VAPs in the AP may set the BSS color subfield of the first HE Operation element, it transmits to a value in the range of 1 to 63 and maintains that value until the BSS color is changed. In the meantime, another one of the two VAPs in the AP may set the BSS color subfield of the first HE Operation element it transmits to a different value in the range 1 to 63 and maintain that value until the BSS color is changed.

At 306, the first AP detects that the first BSS color is used by a neighboring BSS. For example, in the implementation illustrated in FIG. 1A, the AP 110-1 is located near the edge of the BSS 140 and may detect that the first BSS color is used by a neighboring BSS. In some example implementations, the first AP may receive a frame containing a BSS indicator indicating the first BSS color from a further device. Then, the first AP determines that the further device is a member of the neighboring BSS based on a BSS identification (BSSID) contained in the frame. The first AP determines that the first BSS color is used by the neighboring BSS. For example, the AP 110-1 may determine that a BSS color collision has occurred if it receives data from on its operating channel from an OBSS device containing the same BSS color.

In some alternative implementations, the first AP may receive a BSS color collision report of a BSS color collision event between the BSS and the neighboring BSS from the client device. Then, the first AP determines that the first BSS color is used by the neighboring BSS. For example, the client device 120-1 may automatically send a color collision report to the associated AP 110-1 when it detects that a color collision has occurred. The BSS color collision report may contain BSS color information of all OBSSs from which the client device 120-1 may detect so that the AP 110-1 is able to select a new non-overlapping BSS color.

At 308, the first AP changes the first color of the BSS to a third color for communications between the first AP and the client device. In this case, the third color is different from the first color and the second color. For example, in the implementation illustrated in FIG. 1A, the AP 110-1 may change the first color of the BSS to a third color, for example, of a BSS color value 10, while maintaining the second color for communications between the APs.

In the illustrated implementation, only the BSS color for the communications between the AP and the clients, which was involved in a BSS color collision, has been changed, and the BSS color for communications between the APs will be maintained. Thus, the BSS color switch procedure between the APs, which usually takes some time, will be spared, thereby facilitating the recovery from the BSS color collision, especially for the mesh networks. For example, when a BSS color collision occurs, conventionally, all the links in a mesh network with a linear topology have to change the BSS color sequentially from a mesh point to the mesh portal point one by one, which would definitely require a large amount of time. Thus, with the BSS color switch mechanism in accordance with the present disclosure, the link flapping and delay in the whole mesh topology can be reduced.

In some example implementations, the AP and the client device may be MLD devices. In this case, more than one link has been established between the AP and its associated device. When a BSS color collision is detected, the AP may transmit the BCCA information on all the links to facilitate the transmission of the BCCA information, especially when the BCCA information is carried in the dedicated BCCA frame instead of a beacon.

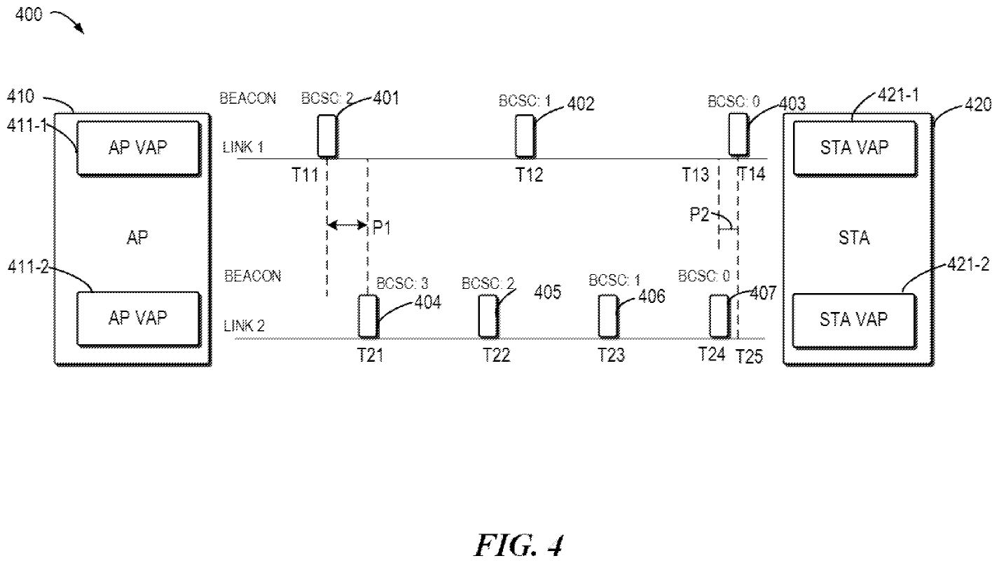

FIG. 4 illustrates a schematic diagram for an example BSS color switch procedure 400 in accordance with some example implementations of the present disclosure. For description purposes, the procedure 400 will be described in association with FIGS. 1A-1C and 2. For example, the procedure 400 may be implemented between an AP 410 corresponding to one of the plurality of APs 110 as illustrated in FIGS. 1A-1C and a station (STA) 420 corresponding to a client device associated with the AP under a communication framework, as illustrated in FIG. 2.

When the AP detects a BSS color collision, the AP may initiate a BSS color switch procedure by announcing an upcoming BSS color change using the BSS color change announcement (BCCA) element. The BCCA element may be carried in beacons, probe responses, (re) association response, and a dedicated BCCA frame.

As illustrated in FIG. 4, the AP 410 and the STA 420 are MLDs. The AP 410 includes an AP VAP 411-1 and an AP VAP 411-2. Accordingly, the STA 420 includes an STA VAP 421-1 and an STA VAP 421-2. A link 1 is established between the AP VAP 411-1 and the STA VAP 421-1, and a link 2 is established between the AP VAP 411-2 and the STA VAP 421-2. The BCCA elements are contained in the beacons from both the AP VAP 411-1 and the AP VAP 411-2 to announce BSS color changes on both links. The BCCA element contains a BSS color switch countdown (BCSC) field, which is the number of color switch announcements sent before switching to a new color. The range of the BCSC is 0-100, and its unit is TBTT.

The AP VAP 411-1 transmits a beacon 401 at a TBTT T11 to announce the BSS color change on link 1. A BSS color switch countdown (BCSC) field in the BCCA carried in the beacon 401 is 2. Then, the AP VAP 411-1 transmits a beacon 402 at a TBTT T12 with a BCSC of 1. At last, the AP VAP 411-1 transmits a beacon 403 at a TBTT T14 with a BCSC of 0. After the STA VAP 421-1 receives the beacon 403 at the time point T14, the STA VAP 421-1 changes the original BSS color to a new BSS color indicated by the BCCA element.

In parallel, the AP VAP 411-2 transmits a beacon 404 with a BCSC of 3 at a TBTT T21 to announce the BSS color change on link 2. The TBTT T21 is later than the TBTT T11 by a period P1. Then, the AP VAP 411-2 transmits a beacon 405 at a TBTT T22 with a BCSC of 2 and a beacon 406 at a TBTT T23 with a BCSC of 1. At last, the AP VAP 411-2 transmits a beacon 407 at a TBTT T24 with a BCSC of 0. However, the TBTT T24 is earlier than the TBTT T14 by a period P2. If the STA VAP 421-1 changes the original BSS color to a new BSS color indicated by the BCCA element at the TBTT T24, the color of link 1 will still be unchanged. As a result, there would be a BSS color mismatch between the link 1 and the link 2. In order to avoid the BSS color mismatch, the AP VAP 411-2 may suspend the BSS coloring on the link 2.

In general, the AP may determine a first BSS color switch time for the first link based on a first TBTT and a first BCSC for the first link and determine a second BSS color switch time for the second link based on a second TBTT and a second BCSC for the second link. If the AP determines that the first BSS color switch time is greater than the second BSS color switch time, the AP suspends the use of BSS color on the second link at the second BSS color switch time and change the first BSS color to the third BSS color on the first link and the second link at the first BSS color switch time.

For example, the link 1 may use a TBTT of 200 time units (UTs), and a BCSC of 2. In the meantime, the link 2 may use a TBTT of 100TUs, and a BCSC of 3. As a result, there is a time offset between the BSS color switch time on the link 1 and the BSS color switch time on the link 2 due to the offset between the TBTTs. In this case, the AP VAP 411-2 will force BSS color to be disabled by changing the BSS disabled field to 1 or setting BSS color value as 0 (outside of the defined range of 1-63) on the link 2. At a time point T25 corresponding to the TBTT T14, the STA VAP 421-2 changes the original BSS color to a new BSS color indicated by the BCCA element.

With the illustrated implementation, the links between MLDs use the same BSS color, and the BSS color switch time is aligned so that the BSS coloring mismatch issue that happened on different links for MLDs is reduced.

In some further implementations, TID-to-link mapping or other traffic indication methods may be incorporated to avoid the traffic jitter because the TBTT offset factor among the links. It should be appreciated the number of the links established between MLDs, as illustrated, is only an example. The number of links established between MLDs could also be more than two.

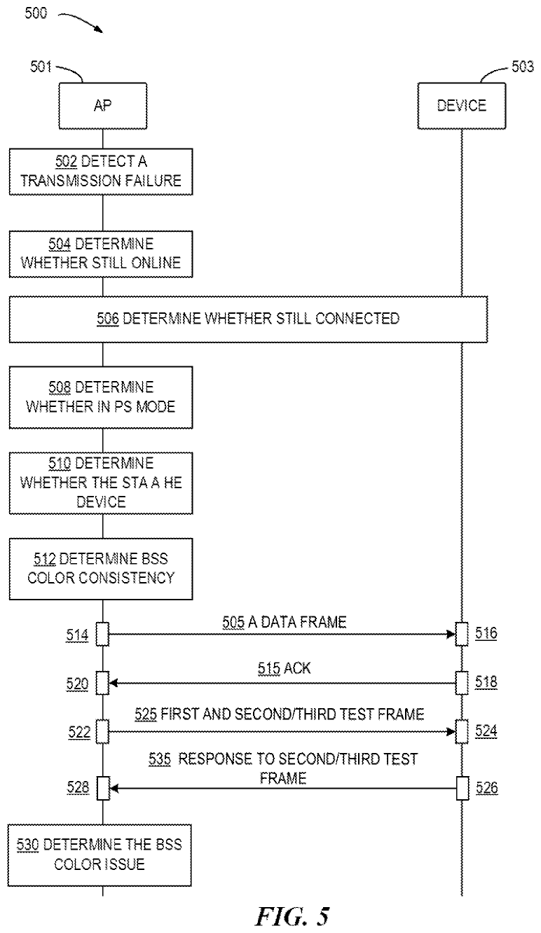

FIG. 5 illustrates a schematic diagram for an example BSS color issue detection procedure 500 in accordance with some example implementations of the present disclosure. For description purpose, the procedure 400 will be described in association with FIGS. 1A-1C and 2. The issue detection procedure 500 may be implemented between an AP 501 corresponding to one of the plurality of APs 110 as illustrated in FIGS. 1A-1C and a device 503 corresponding to a client device or an AP associated with the AP under a communication framework, as illustrated in FIG. 2.

At 502, the AP 501 detects a transmission issue with the device 503. At 504, the AP 501 determines whether the device 503 is still online. For example, if the device responds to a ping packet, the device 503 is determined to be online. At 506, after the AP 501 determines that the device 501 is online, the AP 501 determines whether the device 503 is still connected by sending data frames and checking for acknowledgement frames. At 508, after the AP 501 determines that the device 503 is still connected, the AP 501 determines whether the device 501 is in power save mode or in an inter power save mode if the device 503 supports it. At 510, after the AP 501 determines that the device 503 is not in the power save mode, the AP 501 determines whether the device 503 is a HE device. After the AP 501 determines that the device 503 is a HE device, the AP 501 determines whether the BSS color indicated by the HE operation element in the beacon transmitted by the AP 501 is the same as the BSS color indicated by the HE preamble in the frames transmitted by the device 503. At 514, after the AP 501 determines that there is no BSS color issue, the AP 501 transmits a data frame 505 at a basic rate. Upon receipt of the data frame 505 at 516, the device 501 responds to the AP 501 with an acknowledgment frame 515 at 518. At 520, the AP 501 receives the acknowledgement frame 515. At 522, the AP 501 transmits a first and second or third test frame 525 to the device 501. For example, the first test frame is a HE frame, the second test frame may be a non-HE single user (SU) frame, and the third test frame may be a data frame with a BSS color value of 0. Upon receipt of the first and second or third frame 525 at 524, the device 503 transmits a response to the second or third test frame 535 to the AP 501. At 528, the AP 501 receives the response to the second or third test frame 535 without a response to the first test frame. At 530, the AP 501 determines that a BSS color mismatch issue occurs.

In some example implementations, in order to address the BSS color mismatch issue, the AP may initiate a BCCA procedure to trigger a BSS color switch procedure so that the BSS color can be aligned. If this fails, the AP may transmit a de-association frame to the device to cause the device to re-associate with the AP so that the BSS color can be aligned again. With the illustrated implementation, the BSS color mismatch issue can be accurately determined.

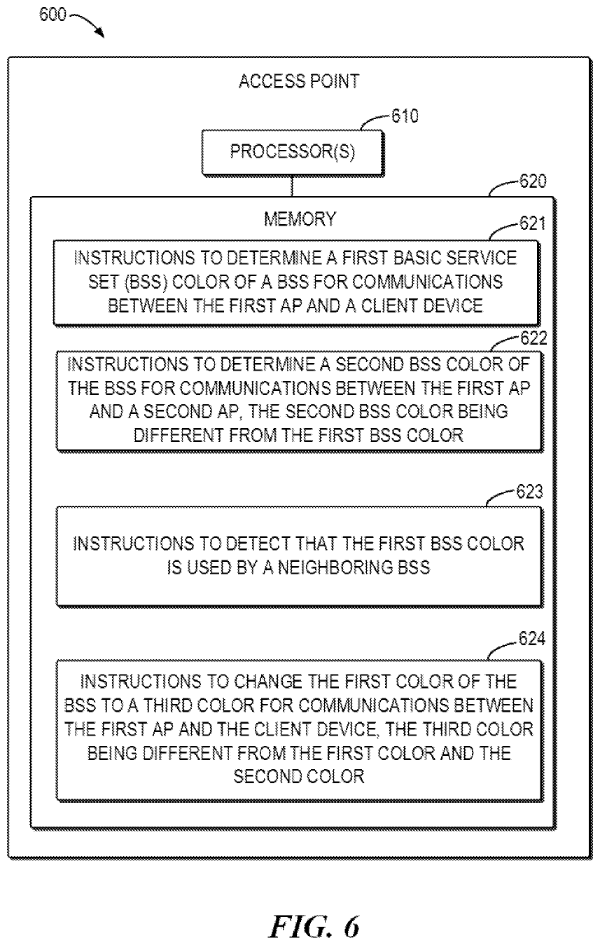

FIG. 6 illustrates a block diagram of an example AP 600 in accordance with some example implementations of the present disclosure. The AP 600 may be corresponding to one of the plurality of APs 110, as illustrated in FIGS. 1A-1C. The AP 600 comprises at least one processor 610 and a memory 620 coupled to at least one processor 610. The memory 620 stores instructions to cause at least one processor 610 to implement actions.

As illustrated in FIG. 6, the memory 620 stores instructions 621 to determine a first basic service set (BSS) color of a BSS for communications between the first AP and a client device. The memory 620 further stores instructions 622 to determine a second BSS color of the BSS for communications between the first AP and a second AP. In this case, the second BSS color is different from the first BSS color. The memory 620 further stores instructions 623 to detect that the first BSS color is used by a neighboring BSS. The memory 620 further stores instructions 624 to change the first color of the BSS to a third color for communications between the first AP and the client device, the third color being different from the first color and the second color.

The present disclosure also provides at least one computer program product tangibly stored on a non-transitory computer-readable storage medium. The computer program product includes program codes or instructions that can be executed to carry out the method as described above with reference to FIG. 3 and procedures as described above with reference to FIGS. 2 and 5.

While the above discussion used a Wi-Fi communication standard as an illustrative example, in other implementations a wide variety of communication standards and, more generally, wireless communication technologies may be used. Furthermore, while some of the operations in the foregoing implementations were implemented in hardware or software, in general, the operations in the preceding implementations can be implemented in a wide variety of configurations and architectures. Therefore, some or all of the operations in the foregoing implementations may be performed in hardware, software, or both.

It should be noted that specific terms disclosed in the present disclosure are proposed for convenience of description and a better understanding of example implementations of the present disclosure, and the use of these specific terms may be changed to another format within the technical scope or spirit of the present disclosure.

Program codes or instructions for carrying out methods of the present disclosure may be written in any combination of one or more programming languages. These program codes or instructions may be provided to a processor or controller of a general-purpose computer, special-purpose computer, or other programmable data processing apparatus, such that the program codes, when executed by the processor or controller, cause the functions/operations specified in the flowcharts and/or block diagrams to be implemented. The program code or instructions may execute entirely on a machine, partly on the machine, as a stand-alone software package, partly on the machine and partly on a remote machine, or entirely on the remote machine or server.

In the context of this disclosure, a computer-readable medium may be any tangible medium that may contain or store a program for use by or in connection with an instruction execution system, apparatus, or device. The computer-readable medium may be a computer-readable signal medium or a computer-readable storage medium. A computer-readable medium may include but not limited to an electronic, magnetic, optical, electromagnetic, infrared, or semiconductor system, apparatus, or device, or any suitable combination of the foregoing. More specific examples of the computer-readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order illustrated or in sequential order or that all illustrated operations be performed to achieve desirable results. In certain circumstances, multitasking and parallel processing may be advantageous. Certain features that are described in the context of separate implementations may also be implemented in combination in a single implementation. Conversely, various features that are described in the context of a single implementation may also be implemented in multiple implementations separately or in any suitable sub-combination.

In the foregoing Detailed Description of the present disclosure, reference is made to the accompanying drawings that form a part hereof, and in which is illustrated by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

What is claimed is:

1. A method comprising:
determining, by a first access point (AP), a first basic service set (BSS) color of a BSS for communications between the first AP and a client device;
determining, by the first AP, a second BSS color of the BSS for communications between the first AP and a second AP, the second BSS color being different from the first BSS color;
detecting, by the first AP, that the first BSS color is used by a neighboring BSS; and
changing, by the first AP, the first color of the BSS to a third color for communications between the first AP and the client device, the third color being different from the first color and the second color.

2. The method of claim 1, wherein detecting that the first BSS color is used by the neighboring BSS comprises:
receiving, by the first AP from a further device, a frame containing a BSS indicator indicating the first BSS color;
determining, by the first AP, that the further device is a member of the neighboring BSS based on a BSS identification (BSSID) contained in the frame; and
determining, by the first AP, that the first BSS color is used by the neighboring BSS.

3. The method of claim 1, wherein detecting that the first BSS color is used by the neighboring BSS comprises:
receiving, by the first AP from the client device, a BSS color collision report of a BSS color collision event between the BSS and the neighboring BSS; and
determining, by the first AP, that the first BSS color is used by the neighboring BSS.

4. The method of claim 1, wherein changing the first color of the BSS to the third color comprises:
determining, by the first AP, that both a first link and a second link established between the first AP and the client device use the first BSS color; and
transmitting, by the first AP to the client device, BSS color change announcement (BCCA) information on the first link and the second link, the BCCA information indicating a change of the first BSS color to the third BSS color.

5. The method of claim 4, wherein transmitting the BCCA information on the first link and the second link comprises:
determining, by the first AP, a first BSS color switch time for the first link based on a first target beacon transmission time (TBTT) and a first BSS color switch count (BCSC) for the first link;
determining, by the first AP, a second BSS color switch time for the second link based on a second target beacon transmission time (TBTT) and a second BSS color switch count (BCSC) for the second link;
determining, by the first AP, that the first BSS color switch time is greater than the second BSS color switch time;
suspending, by the first AP, a use of BSS color on the second link at the second BSS color switch time; and
changing, by the first AP, the first BSS color to the third BSS color on the first link and the second link at the first BSS color switch time.

6. The method of claim 5, wherein suspending the use of BSS color on the second link comprises at least one of:
disabling, by the first AP, a BSS color on the second link; or
changing, by the first AP, the first BSS color on the second link to an undefined color.

7. The method of claim 1, further comprising:
detecting, by the first AP, a transmission failure between the first AP and the client device;
determining, by the first AP, that the first AP is properly associated with the client device;
transmitting, by the first AP to the client device, a first test frame at a basic rate and a second test frame in a non-high efficiency (HE) single user (US) layer or a third test frame with an undefined BSS color value; and
in response to receiving a response to the second test frame or the third test frame without a response to the first test frame, determining, by the first AP, a BSS color collision mismatch as a cause of the transmission failure.

8. The method of claim 7, further comprising:
in response to determining the BSS color mismatch, transmitting, by the first AP to the client device, frames with undefined BSS color values; or

9. The method of claim 8, further comprising:
in response to a failure to receive acknowledgement the frames with undefined BSS color values, triggering, by the first AP, re-association of the client device.

10. The method of claim 1, further comprising:
broadcasting, by the first AP, a first beacon containing a first BSS color indicator and a second beacon containing a second BSS color indicator;
receiving, by the first AP from a device, an association request;
determining, by the first AP, that the client device is not an AP based on the association request; and
transmitting, by the first AP to the client device, an association response containing the first BSS color indicator.

11. The method of claim 10, further comprising:
receiving, by the first AP from the second AP, an association request;
determining, by the first AP, that the client device is an AP based on the association request; and
transmitting, by the first AP to the client device, an association response containing the first BSS color indicator.

12. The method of claim 11, further comprising:
receiving, by the first AP, a data frame;
determining, by the first AP, a BSS color indicator contained in the data frame;
determining, by the first AP, whether the BSS color indicator matches one of the first BSS color indicator and the second BSS color indicator; and
in response to determining that the BSS color indicator matches one of the first BSS color indicator and the second BSS color indicator, determining the frame as an intra frame.

13. The method of claim 12, further comprising:
in response to determining that the BSS color indicator matches neither of the first BSS color indicator and the second BSS color indicator, determining the frame as an inter frame.

14. A first access point (AP) comprising:
at least one processor; and
a memory coupled to the at least one processor, the memory storing instructions to cause the at least one processor to:
determine a first basic service set (BSS) color of a BSS for communications between the first AP and a client device;
determine a second BSS color of the BSS for communications between the first AP and a second AP, the second BSS color being different from the first BSS color;
detect that the first BSS color is used by a neighboring BSS; and
change the first color of the BSS to a third color for communications between the first AP and the client device, the third color being different from the first color and the second color.

15. The first AP of claim 14, wherein to detect that the first BSS color is used by the neighboring BSS, the at least one processor is further caused to:
receive a frame containing a BSS indicator indicating the first BSS color from a further device;
determine that the further device is a member of the neighboring BSS based on a BSS identification (BSSID) contained by the frame; and
determine the first BSS color is used by the neighboring BSS.

16. The first AP of claim 14, wherein to detect that the first BSS color is used by the neighboring BSS, the at least one processor is further caused to:
receive a BSS color collision report of a BSS color collision event between the BSS and the neighboring BSS from the client device; and
determine that the first BSS color is used by the neighboring BSS.

17. The first AP of claim 14, wherein to change the first color of the BSS to the third color, the at least one processor is further caused to:
determine that a first link and a second link established between the first AP and the client device both use the first BSS color; and
transmit BSS color change announcement (BCCA) information on the first link and the second link to the client device, the BCCA information indicating a change of the first BSS color to the third BSS color.

18. The first AP of claim 17, wherein to transmit the BCCA information on the first link and the second link, the at least one processor is further caused to:
determine a first BSS color switch time for the first link based on a first target beacon transmission time (TBTT) and a first BSS color switch count (BCSC) for the first link;
determine a second BSS color switch time for the second link based on a second target beacon transmission time (TBTT) and a second BSS color switch count (BCSC) for the second link;
determine that the first BSS color switch time is greater than the second BSS color switch time;
suspend a use of BSS color on the second link at the second BSS color switch time; and
change the first BSS color to the third BSS color on the first link and the second link at the first BSS color switch time.

19. The first AP of claim 18, wherein to suspend the use of BSS color on the second link, the at least one processor is further caused to:
disable a BSS color on the second link; or
change the first BSS color on the second link to an undefined color.

20. A non-transitory computer-readable medium comprising instructions stored thereon which, when executed by an access point (AP), cause the AP to:
determine a first basic service set (BSS) color of a BSS for communications between the AP and a client device;
determine a second BSS color of the BSS for communications between the AP and a second AP, the second BSS color being different from the first BSS color;
detect that the first BSS color is used by a neighboring BSS; and
change the first color of the BSS to a third color for communications between the AP and the client device, the third color being different from the first color and the second color.
